(19) United States
(12) Patent Application Publication
(10) Pub. No.: US 2025/0390492 A1
(43) Pub. Date: Dec. 25, 2025

(54) INTERMEDIATE QUERY GENERATION FOR LARGE LANGUAGE MODEL-BASED PROCESSING

(71) Applicant: CoreLogic Solutions, LLC, Irvine, CA (US)

(72) Inventors: Kien Trong Trinh, San Diego, CA (US); Marc-Antoine Juaneda, Campbell River (CA); Neda Alipanah, San Diego, CA (US); Matt Delventhal, Temecula, CA (US); Majid Ramezani, Arlington, VA (US); Samuel Shiyou Wang, Irvine, CA (US); Uyen Hoang, San Diego, CA (US); Bin He, Philadelphia, PA (US); Linhai Li, San Diego, CA (US); Huankun Fu, Dallas, TX (US)

(21) Appl. No.: 19/242,845

(22) Filed: Jun. 18, 2025

Related U.S. Application Data
(60) Provisional application No. 63/662,900, filed on Jun. 21, 2024.

(51) Int. Cl. G06F 16/2452; G06F 16/22

(52) U.S. Cl. CPC G06F 16/24522; G06F 16/2237

(57) ABSTRACT

Systems and methods for an agent assistant system to provide answers and insights to property-based questions in a natural language processing environment. Specifically, the agent assistant system as described herein may receive a question or task from a user and generate a query representing the request for information from the user and any other relevant information related to the request. Queries generated by the query generation system may represent an intent of the user-provided question and allow visibility into the request that a model is tasked with handling. In some embodiments, the agent assistant system may generate a natural language summary that represents the information parsed from the user and the task to be executed by the LLM. The summary may serve as a check or validation to confirm that the LLM will generate an accurate response based on the user input.

### CROSS-REFERENCE TO RELATED APPLICATIONS

The present application claims priority from U.S. Provisional No. 63/662,900, filed on Jun. 21, 2024, entitled INTERMEDIATE QUERY GENERATION FOR LARGE LANGUAGE MODEL-BASED PROCESSING, which is incorporated by reference in its entirety.

### BACKGROUND

Real estate agents and brokers (“agents”) utilize various tools in assisting buyers and sellers in real estate transactions. Various online or software-based tools may be available for agents to use for conducting research about properties and/or requesting information. Natural language processing (NLP) applications may provide a conversation-based interface to present information in a conversation-based interface. In some cases, agent-based NLP applications may combine in a seamless interface for property research.

### SUMMARY

One aspect of the disclosure provides a system comprising a computer-readable storage medium storing program instructions. The system further comprises one or more processors configured to execute the program instructions to cause the system to: receive a user question in a natural language interface environment; determine an intent of the user question, wherein the intent relates to a request for information stored in a document data store; input the user question into a large language model (LLM), wherein the LLM is configured to generate: an SQL query based on the intent of the user question and requested information from the document data store, and a natural language summary of the SQL query; retrieve information from the document data store based on the SQL query; retrieve a second query associated with the intent of the user question based on a vector distance; generate a prompt based on the SQL query, the second query, the user question, and the retrieved information from the document data store for input into the LLM to generate an answer to the user question; output the answer in the natural language interface environment; and validate the answer based on user feedback received within the natural language interface environment.

The system of the preceding paragraph can include any sub-combination of the following features: where the program instructions further cause the system to: determine an ambiguity within the user question, display, within the natural language interface environment, an inquiry to resolve the ambiguity, and receive, from a user, a response to the inquiry that resolves the ambiguity; where the program instructions further cause the system to: display the natural language summary in the natural language interface environment; where the answer is at least one of a text response, a table, an image, or a picture; where the user feedback to the answer includes at least one of a positive response, a negative response, an emotion, a reaction, or a comment; where the program instructions further cause the system to: generate a user profile based on the SQL query and the second query, and wherein the LLM is to generate the answer based on a user profile; and where the second query was generated within a current session or a prior session.

Another aspect of the disclosure provides a computer-implemented method comprising: receiving a user question in a natural language interface environment; determining an intent of the user question, wherein the intent relates to a request for information stored in a document data store; inputting the user question into a large language model (LLM), wherein the LLM is configured to generate: an SQL query based on the intent of the user question and requested information from the document data store, and a natural language summary of the SQL query; retrieving information from the document data store based on the SQL query; retrieving a second query associated with the intent of the user question based on a vector distance; generating a prompt based on the SQL query, the second query, the user question, and the retrieved information from the document data store for input into the LLM to generate an answer to the user question; outputting the answer in the natural language interface environment; and validating the answer based on user feedback received within the natural language interface environment.

The computer-implemented method of the preceding paragraph can include any sub-combination of the following features: where the computer-implemented method further comprises: determining an ambiguity within the user question, displaying, within the natural language interface environment, an inquiry to resolve the ambiguity, and receiving, from a user, a response to the inquiry that resolves the ambiguity; where the computer-implemented method further comprises: displaying the natural language summary in the natural language interface environment; where the answer is at least one of a text response, a table, an image, or a picture; where the user feedback to the answer includes at least one of a positive response, a negative response, an emotion, a reaction, or a comment; where the computer-implemented method further comprises: generating a user profile based on the SQL query and the second query, and where the LLM is to generate the answer based on a user profile; and where the second query was generated within a current session or a prior session.

Another aspect of the disclosure provides a non-transitory, computer-readable medium comprising computer-executable instructions for analyzing an image, wherein the computer-executable instructions, when executed by a computer system, cause the computer system to: receive a user question in a natural language interface environment; determine an intent of the user question, wherein the intent relates to a request for information stored in a document data store; input the user question into a large language model (LLM), wherein the LLM is configured to generate: an SQL query based on the intent of the user question and requested information from the document data store, and a natural language summary of the SQL query; retrieve information from the document data store based on the SQL query; retrieve a second query associated with the intent of the user question based on a vector distance; generate a prompt based on the SQL query, the second query, the user question, and the retrieved information from the document data store for input into the LLM to generate an answer to the user question; output the answer in the natural language interface environment; and validate the answer based on user feedback received within the natural language interface environment.

The non-transitory, computer-readable medium of the preceding paragraph can include any sub-combination of the following features: where the computer-executable instructions, when executed, further cause the computer system to: determine an ambiguity within the user question, display, within the natural language interface environment, an inquiry to resolve the ambiguity, and receive, from a user, a response to the inquiry that resolves the ambiguity; where the computer-executable instructions, when executed, further cause the computer system to: display the natural language summary in the natural language interface environment; where the user feedback to the answer includes at least one of a positive response, a negative response, an emotion, a reaction, or a comment; where the computer-executable instructions, when executed, further cause the computer system to: generate a user profile based on the SQL query and the second query, and wherein the LLM is to generate the answer based on a user profile; and where the second query was generated within a current session or a prior session.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a schematic block diagram of an example network environment in which an agent assistant system may operate, according to various aspects of the present disclosure.

FIG. 2A is an example data flow process in which the search and response system of the agent assistant system may operate to generate a response from user interaction, according to various aspects of the present disclosure.

FIG. 2B is an additional example data flow process in which the search and response system may operate to provide an answer to a question, according to various aspects of the present disclosure.

FIG. 2C is an additional example data flow process in which the search and response system may determine an output to a user input, according to various aspects of the present disclosure.

FIG. 3A is an example data flow process in which the query generation system of the agent assistant system may operate to generate a query when data is stored in a relational data store, according to an additional embodiment of the present disclosure.

FIG. 3B is an example data flow process in which the agent assistant system may operate to generate a confidence score, according to an additional embodiment of the present disclosure.

FIG. 4 is an example data flow process in which the query generation system of the agent assistant system may operate to generate a query when data is stored in a vector data store, according to an additional embodiment of the present disclosure.

FIGS. 5A-5C are screenshots of example chat interfaces through which a user may interact with the agent assistant system, according to various aspects of the present disclosure.

FIG. 6 is a block diagram illustrating components of an example computing system that can be used to implement the various systems and methods described herein.

FIG. 7 is flow diagram showing an example routine for generating an answer to a question based on an intermediate SQL query or CQL query, according to various aspects of the present disclosure.

### DETAILED DESCRIPTION

Generally described, aspects of the present disclosure relate to efficient mechanisms for providing large language model (LLM)-generated answers based on intermediate database query generation in a natural language processing environment.

As noted herein, agents typically utilize a variety of software-based tools to aid in researching and identifying real estate properties. Properties and related information may be stored or hosted by servers and organized in large databases. Property research (among other research or searching) is an essential agent task that requires scaling said large databases or other data sources to gather relevant information. In some cases, machine learning-based applications may allow agents to request information from large databases or other sources relating to properties. These models may be configured to quickly scale databases and retrieve relevant information, often taken from property documents and forms, for presentation to the agent (or other user). However, models are often tasked with repeated queries for the same information and/or complex requests that may not be understood by the model. Repeated queries for the same information (e.g., same property, same documents) may result in significant inefficiencies in computational resource costs and time taken. In addition, complex results may result in inaccurate results from the model. Often, models like large language models surface a final inference (e.g., output) as an output without indicating any intermediate operations or intermediate outputs that were used to generate the final inference. Because visibility of a model's inference process may be limited, users may not be able to determine whether the retrieved inferences (e.g., results, answers) are correct or the reasons why the retrieved interferences are incorrect.

As will be appreciated by one of skill in the art in light of the present disclosure, the embodiments disclosed herein improve the ability of computing systems, such as the agent assistant system, to provide answers and insights to property-based questions in a natural language processing environment. Specifically, the agent assistant system may receive a question or task from a user. In some cases, the agent assistant system may generate, via a query generation system, a query representing the request for information from the user and any other relevant information related to the request. Queries generated by the query generation system may represent an intent of the user-provided question and allow visibility into the request that a model is tasked with handling. In some embodiments, the agent assistant system may generate a natural language summary that represents the information parsed from the user and the task to be executed by the LLM. The summary may represent an intermediate operation or output generated by the LLM and may serve as a check or validation to confirm that the LLM will generate an accurate response based on the user input. In addition, display and confirmation of the intermediate operation or output (e.g., a structure query language (SQL) query, a Cassandra query language (CQL) query, a prompt, etc.) may reduce inefficiencies in computational resource costs and improve accuracy of the system.

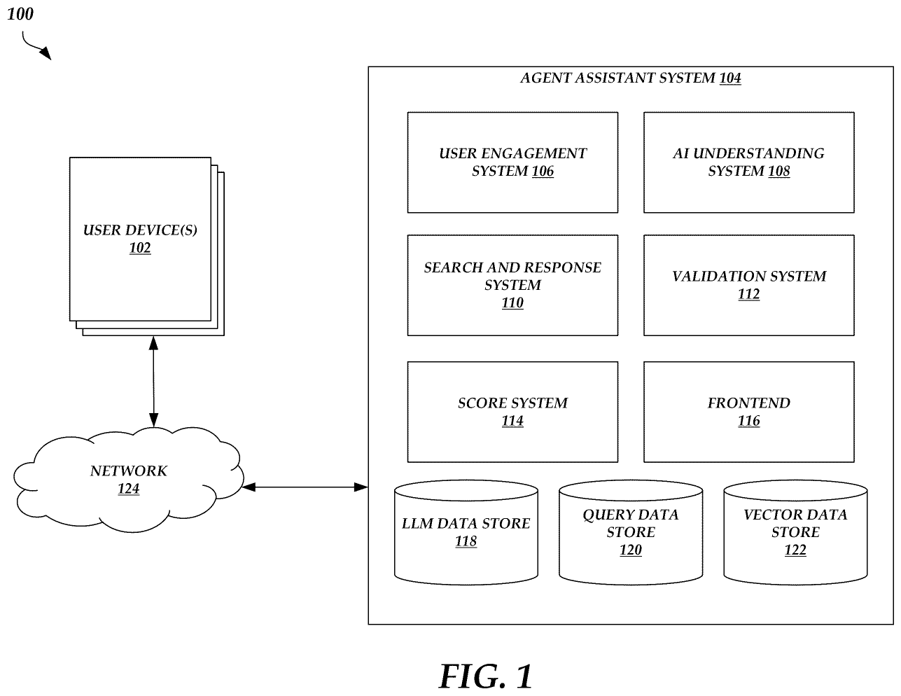

FIG. 1 is a schematic block diagram of an example network environment 100 in which an agent assistant system 104 may operate. The agent assistant system 104 may be configured to provide LLM-generated answers based on intermediate database query generation in a natural language processing environment.

As shown in FIG. 1, the network environment 100 includes user device(s) 102 (hereinafter referred to as “user device 102” for ease of reference), agent assistant system 104, and network 124. Agent assistant system 104 may include user engagement system 106, AI understanding system 108, search and response system 110, validation system 112, score system 114, frontend 116, large language model(s) (“LLM(s)”), query data store 120, and vector data store 122. The components of the agent assistant system 104 within the network environment 100 may be communicatively coupled via network 124. In addition, network 124 may connect the device(s) 102 to the agent assistant system 104 and various components of the agent assistant system 104. The network environment 100 and components of network environment 100 can include various hardware components and software components and can provide functionality as described further herein. In addition, components of the network environment 100 and the agent assistant system 104 may include more or less components.

In various aspects, communications among the various components of the example network environment 100 and agent assistant system 104 may be accomplished via any suitable device, systems, methods, and/or the like. For example, the ay communicate with the user device 102, frontend 116, any of the datastores via any combination of the network 124 or any other wired or wireless communications networks, method (e.g., Bluetooth, WiFi, infrared, cellular, and/or the like), and/or any combination of the foregoing or the like. As further described below, network 124 may comprise, for example, one or more internal or external networks, the Internet, and/or the like.

The network 124 of the network environment 100 can include any appropriate network, including wired network, wireless network, or combination thereof. For example, network 124 may be a personal area network, local area network, wide area network, cable network, satellite network, cellular network, or any other such network or combination thereof. As a further example, the network 124 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 124 may be a private or semi-private network, such as a corporate or university intranet. The network 124 may include one or more wireless networks, such as a Global System for Mobile Communications (GSM) network, a Code Division Multiple Access (CDMA) network, a Long-Term Evolution (LTE) network, C-band, mmWave, sub-6 GHz, or any other type of wireless network. The network 124 can use protocols and components for communicating via the Internet or any of the other aforementioned types of networks. For example, the protocols used by the network 124 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 124 can represent a network that may be local to a particular organization, e.g., a private or semi-private network, such as a corporate or university intranet. In some implementations, devices may communicate via the network 124 without traversing an external network, such as the Internet. In some implementations, devices connected via the network 124 may be walled off from accessing the

Internet. As an example, the network 124 may not be connected to the Internet. Accordingly, e.g., the user device 102 may communicate with the agent assistant system 104 directly (via wired or wireless communications) or via the network 124, without using the Internet. Thus, even if the network 124 or the Internet is down, the agent assistant system 104 may continue to communicate and function via direct communications (and/or via the network 124).

User device 102 may be used to access various components of the network environment 100 and the agent assistant system 104 over the network 124. User device 102 illustratively correspond to any computing device that provides a means for a user or admin to interact with components of the agent assistant system 104. For example, a user, with user device 102, may access the agent assistant system 104 via the frontend 116 to request information or data provided by the agent assistant system 104. In some examples, the frontend 116 may be implemented on user device 102. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, and the like. In some implementations, user device 102 can access a cloud provider network via the network 124 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

Agent assistant system 104 may be configured to assist a user, such as an agent, in various tasks and processes requiring access to stored data. In some embodiments, the agent assistant system 104 may utilize a natural language environment (e.g., a chat interface) to receive tasks or questions from a user and present generated responses. The agent assistant system 104 may have access to various databases, models, and other applications that allow the agent assistant system 104 to provide comprehensive and personalized answers to user-based questions. As shown in FIG. 1, the agent assistant system 104 may include various systems, including a user engagement system 106, an AI understanding system 108, a search and response system 110, a validation system 112, a score system 114, frontend 116. In addition, the agent assistant system 104 may have access to various databases or data stores, such as an LLM data store 118, query data store 120, and vector data store 122. The agent assistant system 104 may include or have access to additional components not shown in FIG. 1, or may have less components than as shown. Each component of the agent assistant system 104 will be discussed in turn below.

To facilitate interaction between the agent assistant system 104 and the user device 102 via the network 124, the agent assistant system 104 includes a frontend 116. Frontend 116 may include any presentation layer (e.g., experience layer) such as a user-facing interface or platform through which a user of the user device 102 may access and interact with the agent assistant system 104.

In some embodiments, the agent assistant system 104 may be displayed in the frontend 116 as a chat interface. The chat interface may include any conversational or natural language interface that allows users to interact with the agent assistant system 104. To interact with the agent assistant system 104, users may provide input to the frontend 116, such as by typing or sending messages (e.g., text-based), images, video, voice or audio messages, and the like. Interactions and other inputs from the user may be displayed in the frontend 116, such as in a chat history or conversation area. In addition, the chat interface may also include displaying messages or responses generated by the agent assistant system 104. In some embodiments, the agent assistant system 104 may provide messages (e.g., text-based), images, videos, tables, voice or audio message, etc. to the user via the frontend 116. Responses, information, and other data retrieved or generated by the agent assistant system 104 may be displayed in the frontend 116, such as in the chat history or conversation area.

LLM data store 118 may be configured to store large language models and/or any other algorithms or models to be accessed by the agent assistant system 104. LLMs stored in the LLM data store 118 may include any engine, service, application, model, program, or process configured to process requests. LLMs may include a natural language processing (NLP) model or any other model that is configured to process a query, such as a SQL query or a CQL query, and generate an answer. In some embodiments, the agent assistant system 104 may access a single LLM stored in the LLM data store 118 to generate a query and retrieve document information (e.g., property information). The agent assistant system 104 may also access a stack (or multiple) LLMs stored in the LLM data store 118 to generate a query and retrieve document information.

Query data store 120 may be configured to store data relating to generated queries (e.g., SQLs, CQLs, etc.). Query data store 120 may be a relational database or any other database type configured to store data in a lookup or tabular format. In some embodiments, the query data store 120 may store information relating to documents (e.g., property documents) and other data in said lookup or tabular format. As will be discussed below, the query generation system 210 may be configured to generate queries. Generated queries may be stored in the query data store 120.

In some embodiments, user input (e.g., user question 202) is used to customize and personalize a user profile associated with the agent assistant system 104. The user profile can include information relating to a user's behavior, interest, past searches/questions/inquiries, patterns, preferences, and the like. In some embodiments, based on the inquiries (e.g., user question 202) sent to the agent assistant system 104 by the user, the agent assistant system 104 may maintain the inquiries to further personalize the user profile. In some examples, each user question 202 may be stored in the query data store 120 (from a past (or prior) or current session) and labeled with the user. In some embodiments, the agent assistant system 104 summarizes, classifies, and compares each user question 202. For example, each user question 202 may be compared against past questions asked by the user to determine patterns, interests, or behaviors of the user. The agent assistant system 104 may determine a similarity of each user question 202 with past questions stored in the query data store 120. In some embodiments, the agent assistant system 104 utilizes or accesses a model to determine a similarity (e.g., semantic similarity, cosine distance or cosine similarity based on a vector derived from a new question 202 and one or more vectors derived from previous question(s), etc.) between a new question 202 and a previous question or a previous set of questions. Each question may be associated with a similarity score, or may be stored in the query data store 120 within a vector space or other embedding space. Similarities or dissimilarities between questions may indicate a trend or new behavior of the user. For example, a low similarity score (e.g., a similarity score less than 50, less than 25, less than 10, etc. on a scale of 0-100) associated with a new question 202 may indicate that the user is exhibiting a new trend or behavior. In some embodiments, agent assistant system 104 generates and maintains the user profile based on the user input (originating from the user question 202).

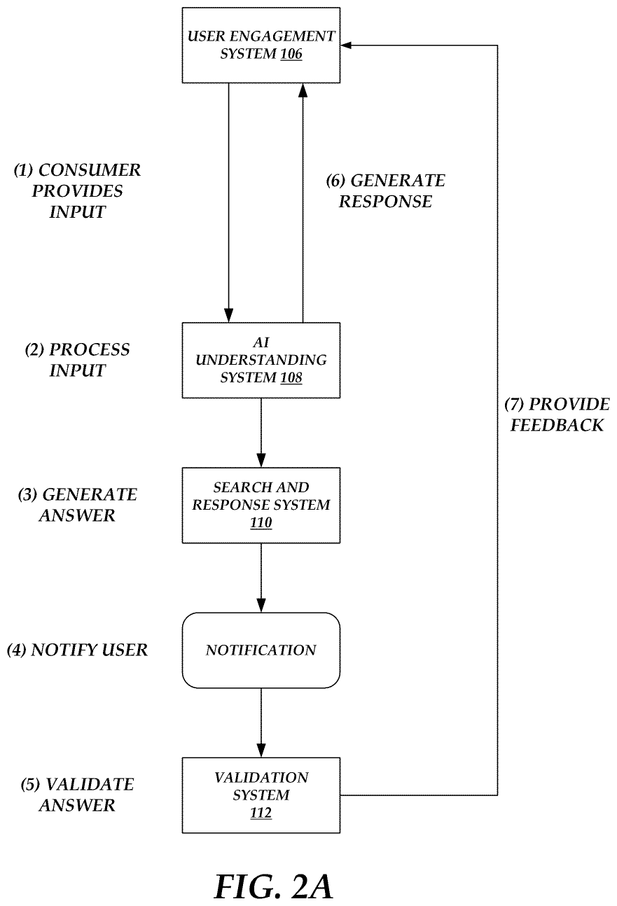

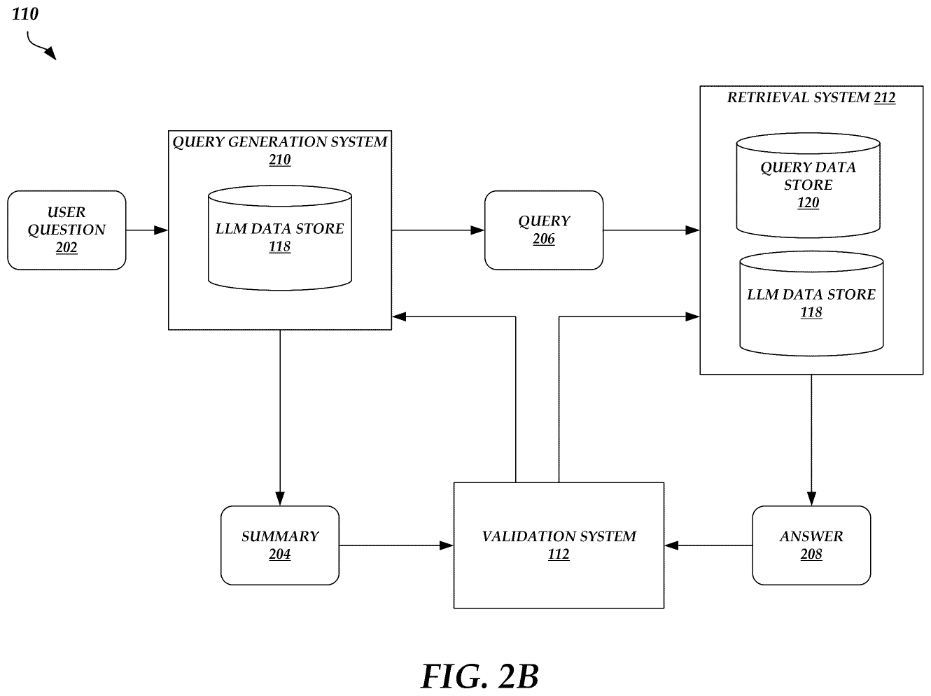

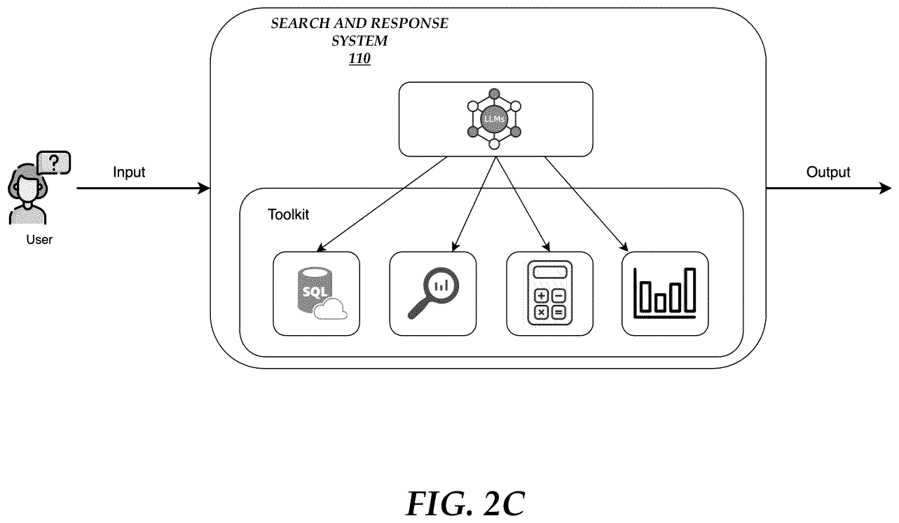

Components of the agent assistant system 104 may access the user profile and can generate recommendations or processes that are personalized to the user. For example, the retrieval system 212 (see FIG. 2B) may access results or recommendations based on the user profile. In addition, new features or results may be recommended to the user. In some embodiments, the agent assistant system 104 may provide suggestions or other recommendations to the user based on the user profile while the user is accessing the agent assistant system 104. For example, auto-complete suggestions or other suggestions may be presented to a user while the user is typing or entering a question into the user engagement system 106 (e.g., via textbox). Auto-complete suggestions may include questions or phrases that may be interesting or relevant to a user, based on the user profile.

Vector data store 122 may be configured to store data in vector format. In some embodiments, the vector data store 122 may store information relating to documents, such as documents relating to properties. As will be discussed in more detail below, document data may be parsed into embeddings for storage in the vector data store 122. In addition, user questions may also be parsed into embeddings for storage in the vector data store 122. These vectors may be accessed by the query generation system 210 in generating queries.

Search and response system 110 may be configured to generate queries or prompts that represent a request for data or information from the agent assistant system 104. The search and response system 110 may access a question or task posed by a user of the agent assistant system 104. The search and response system 110 may identify the question as pertaining to a request for specific information. To prepare the question for input into an LLM for searching (or generation of the answer), the search and response system 110 may first generate a query that parses relevant information from the question into various fields/keywords that will be used in the search. In response to accessing a question, the search and response system 110 may input the question (e.g., text-based) into an LLM to determine a query. The LLM may output a query, such as in the form of a SQL or CQL query, based on the question and any related information. The SQL query may include specific fields and corresponding information related to those fields. In addition to generation of the query 206, the search and response system 110 may generate a summary 204. The summary 204 may represent the information parsed from the user question 202 and the task to be executed by the LLM, expressed in natural language. The summary 204 may serve as a check or validation to confirm that the LLM will generate an accurate response. For example, a user may view the summary 204 in the frontend 116 to confirm that the answer generated by the agent assistant system 104 is correct. Generated SQL queries may be stored in a database, such as the query data store 120 and/or other database. In some embodiments, the agent assistant system 104 accesses similar or related queries that have already been generated and stored (e.g., where two queries can each be converted into vectors based on the strings therein and may be similar if the vectors are within a threshold distance of each other). The agent assistant system 104 may utilize similar queries in generating a prompt for input into the LLM(s) for generation of an answer to the user question 202.

Search and response system 110 may be configured to generate an answer to the user question based on a query. In some embodiments, the search and response system 110 may generate a query that represents a request for information (e.g., property data or statistics). Upon receiving or obtaining the query (or queries), the search and response system 110 may input the query into an LLM (such as LLMs stored in LLM data store 118) configured to generate an inference. In some cases, the search and response system 110 access a single LLM or multiple LLMs in generating an answer based on the query. In some embodiments, the answer generated by the LLM may be in various formats. For example, the LLM may output text data, a table, an image, a picture, or any other format.

In response to the generation of an answer based on the query, the agent assistant system 104 may output or transmit the answer. The agent assistant system 104 may output the answer to the user via the frontend 116, such as in a chat interface. The answer may be displayed in the chat interface as a response to the user (e.g., chat/message/dialog bubble). In some embodiments, the agent assistant system 104 may respond to the user in a dialogue format. Images, tables, text, and any other content may be presented to the user in the frontend 116 as part of the answer provided by the agent assistant system 104. In addition, the agent assistant system 104 may present the answer in a natural language format. For example, the agent assistant system 104 may respond to a user's typed question in the chat interface with a dialogue-based response. In some cases, if the agent assistant system 104 was unable to answer the user's question, the agent assistant system 104 may respond with a follow up question or request for additional information.

Validation system 112 may be configured to validate the responses generated by the agent assistant system 104 and its components. To validate a response, the validation system 112 may receive a user input corresponding to feedback. Feedback can include any indication from the user, such as a positive response (e.g., thumbs up, liking a response message, etc.), a negative response (e.g., thumbs down, disliking a response message, etc.), any other emotion or reaction, or a comment. As described above, in some embodiments, the agent assistant system 104 may output a generated response to the user in a chat interface. The user may respond to the generated response with a thumbs-up or thumbs-down emoji/emoticon, or any other sort of input feedback.

In some embodiments, the validation system 112 may utilize feedback provided by the user to adjust various components of the agent assistant system 104. In some embodiments, the feedback collected by the validation system 112 may be used to train the LLMs stored in the LLM data store 118.

In some embodiments, the validation system 112 may notify the user of a generation of the response generated by the retrieval system 212 before sending the response to another party. This process may allow the user (e.g., agent) to review the generated response before sending to the client, etc.

User engagement system 106 may be configured to collect information, such as user information or consumer information. This information may be collected to provide users of the agent assistant system 104 with information pertaining to potential clients, leads, other agents/brokers, available listings, etc. The user engagement system 106 may collect information from various data sources, such as other applications, programs, advertisements, posts, listings, and the like. For example, information can be sourced from social media items, such as posts, advertisements, messages, etc. that may be shared, clicked, or otherwise interacted with by consumers. User engagement information may include information pertaining to potential clients, such as names, emails, phone numbers, street addresses, areas of interest, price ranges, desired property characteristics (e.g., recent construction, number of bedrooms, amenities). This information may be stored and accessed by the agent assistant system 104 in generating answers to tasks, etc. For example, a user might ask the agent assistant system 104 whether there are any potential clients looking for properties in X location. In response to this question, the agent assistant system 104 may access data collected by the user engagement system 106 to determine whether there are clients in that location. In some embodiments, other components of the agent assistant system 104 may access the user engagement system 106.

Score system 114 may be configured to provide quantitative measures associated with information accessed by the agent assistant system 104. As noted above, the user engagement system 106 may be configured to collect information pertaining to potential clients. The score system 114 may determine a score pertaining to the potentiality or seriousness of the client/lead (e.g., a realist sell score). The score may indicate the likelihood that a particular client is ready or available for participating in a real estate transaction. In some embodiments, the score system 114 determines a score associated with a potential client based on user engagement information, such as recent posts, inquiries, search histories, and the like. The score system 114 may display the score alongside an answer 208 or other information.

Agent assistant system 104 also includes AI understanding system 108. This system may be associated with the search and response system 110 to process the user question 202. In some embodiments, the AI understanding system 108 system utilizes natural language processing (NLP), voice or text, to understand a user's request based on the language in the user question 202. The AI understanding system 108 may also be associated with the retrieval system 212 to process the generated answer 208 to be in natural language format. This allows the agent assistant system 104 to respond to a user question 202 in a conversational or dialogue format.

In some embodiments, the agent assistant system 104 is configured to handle ambiguities in the user question 202. The AI understanding system 108 (or other component of the agent assistant system 104) may be configured to determine whether an ambiguity (or multiple ambiguities) exist within the user question 202. Ambiguities in the user question 202 can include any one or combination of a location ambiguity, a property characteristic ambiguity, a valuation or pricing ambiguity, a property status or availability ambiguity, a property type ambiguity, or any other phrase, word within the user question 202 that can result in multiple interpretations. A location ambiguity can arise, for example, when the user question 202 includes a city with the same name as cities in other locations (e.g., “How many homes are for sale in Portland?” contains a location ambiguity because it is not clear whether the question is referring to Portland, OR or Portland, ME). A property characteristic ambiguity can arise due to varying definitions of features (e.g., lot size, beds, baths, area, size, footprint). Valuation or pricing ambiguities can arise from terms that can have different meanings, such as “market value” as either assessed value or estimated value, “price range” as either listing price or sale price, “luxury property” as being a subjective term. Similarly, property status and availability ambiguities can arise from terms such as “active” (actively listed for sale v. actively under contract) or “new homes” (newly built v. newly listed). Property type ambiguities can arise from different definitions of types: “multi-family” (no set number of units/rooms), “townhouses,” “detached homes,” “manufactured homes” (mobile homes v. modular homes), “ranch-style” (no clear definition). Based on the determined ambiguity, the user may be prompted by the agent assistant system 104 to provide additional information or clarity.

To determine whether the user question 202 contains an ambiguity, the AI understanding system 108 may access a model, such as a natural language model (NLP) or LLM (stored in the LLM data store 118). The AI understanding system 108 may input the user question 202 into a model configured to identify ambiguities within the question 202. In some embodiments, the AI understanding system 108 determines, by the model, the ambiguity and a follow up question or inquiry for the user to provide additional information to resolve the ambiguity. For example, the AI understanding system 108 accesses or receives the question “How many commercial buildings are available in Springfield?” The AI understanding system 108 may input the question and a prompt (e.g., find any ambiguities in the question) into a model configured to determine whether there are any ambiguities. The model may determine that “Springfield” is a location ambiguity because it is not clear in the question whether the user is referring to Springfield in IL, MA, MO, NJ, etc. In addition to determining that there is an ambiguity in the question, the model may determine the information that is needed to resolve the ambiguity. In some embodiments, the search and response system 110 or other user-facing component of the agent assistant system 104 may generate a list for the user to check or select the option to resolve the ambiguity. For the example above, the user may be prompted to select which Springfield is being referred to in the question. In some embodiments, the user may be prompted to provide additional information to resolve the ambiguity via text, selection, or other method.

In some embodiments, the model used to determine ambiguities is trained on ambiguity training data. Training data can include example questions or inquiries with ambiguities (e.g., location ambiguity, a property characteristic ambiguity, a valuation or pricing ambiguity, a property status or availability ambiguity, a property type ambiguity, and the like). The training data may be labeled for various tasks, such as binary classification of sentences as ambiguous or unambiguous and named entity recognition (NER) to identify ambiguous entities when ambiguity is present.

In some embodiments, the agent assistant system 104 includes additional components than as shown in FIG. 1. Additional components or systems may be communicatively coupled with other components of the user engagement system 106. For example, the agent assistant system 104 can include an agent notification system. This system may notify, via the frontend 116, the user or agent of the user question 202 (or other question from the client/consumer) and the answer 208 generated by the agent assistant system 104. In some cases, the agent notification and validation system may notify the user to allow the user to review and validate the answer 208 and corresponding information before the answer 208 is sent to the consumer.

FIG. 2A is an example data flow process in which the search and response system 110 of the agent assistant system 104 may operate to provide an answer to a question.

User engagement system 106 may collect information from various data sources, such as other applications, programs, advertisements, posts, listings, and the like. At (1), the input or information may be transmitted by the agent assistant system 104 to the AI understanding system 108. In some embodiments, user engagement system 105 receives information from the user, such as a question or task, via the frontend 116.

At (2), in some embodiments, the AI understanding system 108 system utilizes natural language processing (NLP), voice or text, to understand user engagement based on the language in the user engagement/information. In some embodiments, the AI understanding system 108 is configured to handle and resolve ambiguities within the information from the user (e.g., question, task) as described above.

In response to processing by the AI understanding system 108, the user input and other information generate by the AI understanding system 108 may be transmitted to the search and response system 110. Search and response system 110 may, at (3), generate an answer to the user question based on a query. In some embodiments, the search and response system 110 may generate a query that represents a request for information (e.g., property data or statistics). Upon receiving or obtaining the query (or queries), the search and response system 110 may input the query into an LLM (such as LLMs stored in LLM data store 118) configured to generate an inference. In some cases, the search and response system 110 access a single LLM or multiple LLMs in generating an answer based on the query. In some embodiments, the answer generated by the LLM may be in various formats. For example, the LLM may output text data, a table, an image, a picture, or any other format.

Before transmitting the answer to a consumer or client, the user (e.g., agent) may be notified at (4), such as via the frontend 116. This may allow the user to verify or validate the answer before notifications are sent to a final client. For example, at (5), the validation system 112 may be configured to validate responses generated by the agent assistant system 104. To validate, the validation system 112 may receive input from a user to validate the answer, check the answer against verified information, etc. At (6), the generated response can be sent back to the user by the user engagement system 106. In addition, at (7), feedback may be fed back to the user engagement system 106.

FIG. 2B is an example data flow process in which the search and response system 110 of the agent assistant system 104 may operate to provide an answer to a question, according to various aspects of the present disclosure. As shown in FIG. 2B, the search and response system 110 includes additional components, such as the query generation system 210 and the retrieval system 212. In addition, the search and response system 110 may access other components of the agent assistant system 104.

As described herein, the agent assistant system 104 may provide a natural language environment (e.g., a chat interface) to receive tasks or questions from a user, such as user question 202. User question 202 may include any input by the user to the agent assistant system 104, such as a text-based message, an image, a video, a voice or audio message, etc. User question 202 may relate to a request for information regarding properties, clients, potential clients, advertisements, real estate, comparables, and the like. Some questions may involve requests for information stored in databases (e.g., specific property information) or estimates, and as such, may require the generation of a query to retrieve that specific information.

In response to accessing or receiving the user question 202, the agent assistant system 104 may, via the query generation system 210, generate a query 206 corresponding to the user question 202. Query 206 may include any command, code, script, etc. to a model (e.g., LLM) to perform a task. In some embodiments, query 206 may be a structured query language (“SQL”) query that requests information from a database. It is noted that although the present disclosure describes query 206 as a SQL query, this is non-limiting. Query 206 may include any other query or query language, such as data query language (DQL), data definition language (DDL), data control language (DCL), GraphQL, CypherQL, etc.

To generate a query, the query generation system 210 may input the user question 202 into an LLM. In response to the input, the LLM may be configured to output a query 206 based on the user question 202 and any relevant information. The generated query 206 may include the type of information requested and the relevant information from the user question 202. For example, the user question 202 may include “What is the current value of property at 123 Main Street?” The query generation system 210 may input this question into an LLM to generate a query based on the user question 202. Based on this input, the LLM may output a query 206 (e.g., a SQL query, a CQL query, etc.) including the following:
SELECT estimated_value,
   Latitude,
   Longitude
FROM properties
WHERE street number=123
AND street name=‘MAIN ST’;

The query generation system 210 may parse information from the user question 202 into various fields of the query 206. As shown in the example above, the query 206 indicates that the requested task is an estimated/current value of the property as defined by the street_number and street_name fields.

In addition to or alternatively to generation of the query 206, the query generation system 210 may generate a summary 204. The summary 204 may represent the information parsed from the user question 202 and the task to be executed by the LLM, expressed in natural language. The summary 204 may serve as a check or validation to confirm that the LLM will generate an accurate response. For example, a user may view the summary 204 in the frontend 116 to confirm that the answer generated by the agent assistant system 104 is correct.

Upon generation of the query 206, the agent assistant system 104 may, via the retrieval system 212, utilize or execute the query 206 to retrieve the corresponding data from the query data store 120. The query 206 may correspond to a specific area or location (or multiple locations/areas) in the query data store 120 storing information related to the query 206. In response to retrieving the information from the query data store 120, the retrieval system 212 may input the information into an LLM (or multiple LLMs, such as stored in the LLM data store 118) to generate an answer 208. In some cases, the retrieval system 212 accesses a single LLM or multiple LLMs in generating an answer based on the retrieved database information. In some embodiments, the answer generated by the LLM may be in various formats. For example, the LLM may output text data, a table, an image, a picture, or any other format. To generate an answer 208, the LLM may reference various document databases or information stores. In the example described above, the retrieval system 212 may execute the query relating to the estimated property value to access portion(s) of the query data store 120. The retrieval system 212 may access said portion(s) of data for input into the LLM. In response to the input, the LLM may determine that, in this example, the property at 123 Main Street is estimated to be $950,000.

In some embodiments, the agent assistant system 104 may transmit the answer 208 to the user via the frontend 116. The answer 208 may be presented to the user via a chat interface, and may be formatted in a natural language format, such as a response in a conversation/dialogue. For example, the agent assistant system 104 may display the following answer: “The estimated value of the property at 123 Main Street is $950,000.”

In response to the generated and displayed answer 208 in the frontend 116, the user may input additional questions, comments, reactions, and the like. In some embodiments, the validation system 112 may be configured to validate responses generated by the agent assistant system 104. For example, the user may respond to the generated answer 208 by providing feedback. Feedback can include any indication from the user relating to the answer 208, such as a positive response (e.g., thumbs up, liking a response message, etc.), a negative response (e.g., thumbs down, disliking a response message, etc.), any other emotion or reaction, or a comment.

In some embodiments, the validation system 112 may utilize feedback provided by the user to adjust various components of the agent assistant system 104. In some embodiments, the feedback collected by the validation system 112 may be used to train the LLMs stored in the LLM data store 118. In some embodiments, the summary 204 may be accessed by the validation system 112 to adjust various components of the agent assistant system 104.

FIG. 2C is an additional example data flow process in which the search and response system 110 may determine an output to a user input. As shown in FIG. 2C, upon receipt of user input, such as user question 202, the search and response system 110 may determine the intent of the user question 202. For example, the search and response system 110 may determine whether the user question 202 requires a query-based answer based on an intent of the question. Some questions may involve requests for information stored in databases (e.g., specific property information) or estimates, and as such, may involve the generation of a query to retrieve that specific information. Some questions may not involve requests for specific information, or may be handled by other processes or tools (e.g., lower level LLMs). For example, the search and response system 110 may, depending on the user question 202 perform a search or lookup task or a calculation. In addition, the search and response system 110 may generate or plot graphs, tables, charts, or any other output based on retrieved information.

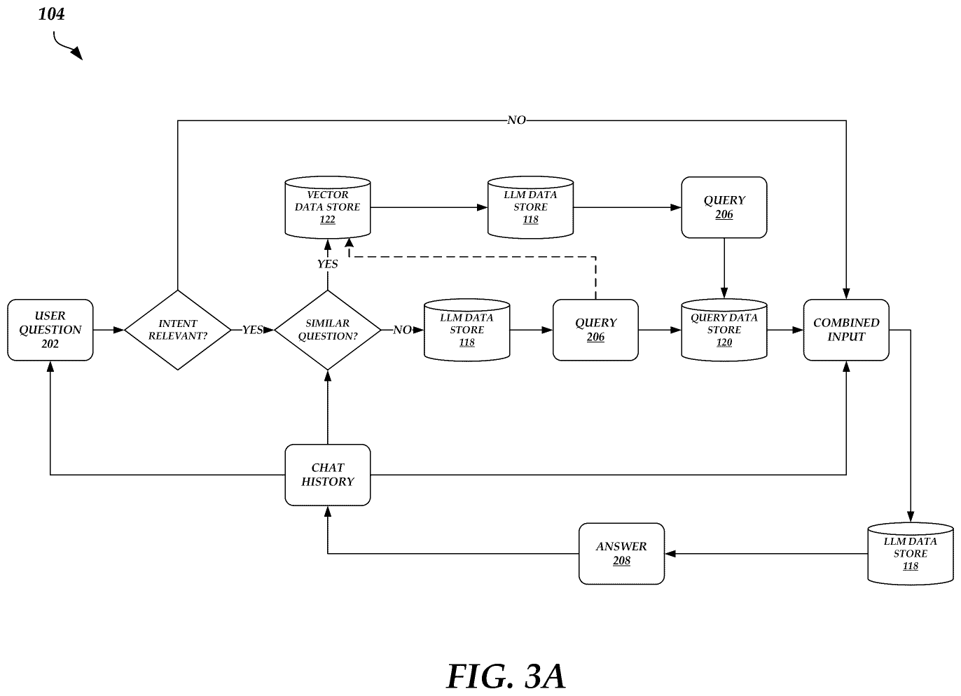

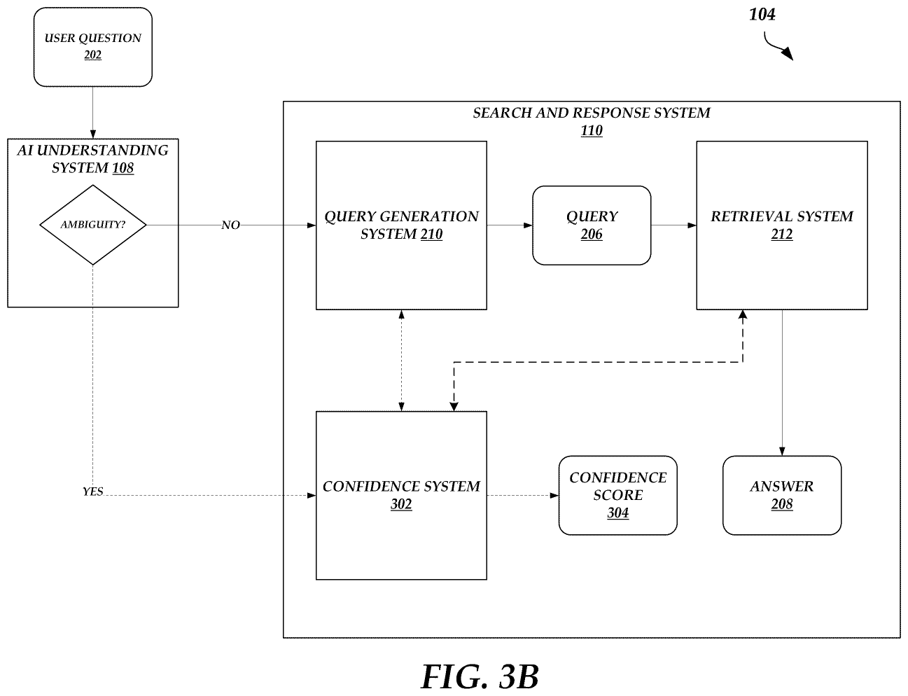

FIG. 3A is an example data flow process in which the search and response system 110 of the agent assistant system 104 may operate to generate a query when data is stored in a relational data store, according to an additional embodiment of the present disclosure.

As described herein with reference to the previous figures, the agent assistant system 104 may provide a natural language environment (e.g., a chat interface) to receive tasks or questions from a user, such as user question 202. User question 202 may include any input by the user to the agent assistant system 104, such as a text-based message, an image, a video, a voice or audio message, etc. User question 202 may relate to a request for information regarding properties, clients, potential clients, advertisements, real estate, comparables, and the like. Some questions may involve requests for information stored in databases (e.g., specific property information) or estimates, and as such, may require the generation of a query to retrieve that specific information.

In some embodiments, the agent assistant system 104 may preprocess the user question 202. At this step, the agent assistant system 104 may determine whether the user question 202 requires a query-based answer based on an intent of the question. Some questions may involve requests for information stored in databases (e.g., specific property information) or estimates, and as such, may involve the generation of a query to retrieve that specific information. Some questions may not involve requests for specific information, or may be handled by other processes or tools (e.g., lower level LLMs). As such, depending on the level of complexity of the question and the available resources, the agent assistant system 104 may determine whether or not the user question 202 requires a query-generated answer from the LLM (e.g., is “not relevant” to the query generation system 210). In the case when the agent assistant system 104 determines that the user question 202 does not require a query to a database, the agent assistant system 104 may pass the user question 202 directly to the retrieval system 212 (or lower level LLMs as shown in FIGS. 3A-3B).

In the case when the agent assistant system 104 determines that the user question 202 does involve a query to a database, the agent assistant system 104 may proceed with additional preprocessing steps.

In response to determining that the user question 202 involves a query to a database (e.g., is “relevant” to the query generation system 210), the agent assistant system 104 may determine whether a similar question exists. At this step, the agent assistant system 104 may determine whether a similar question has been asked by the user. For example, the agent assistant system 104 may determine that a similar question exists in the query data store 120 based on the query previously generated by the query generation system 210. In some cases, the agent assistant system 104 may determine that the same user question 202 has been asked by the user based on a chat/message history in the current or previous session(s). In some cases, the agent assistant system 104 may determine that a similar or related question has been asked by the user in a current or previous session(s). For example, a user may ask “How many bedrooms does Property X have?” The agent assistant system 104 may respond with “Property X has 4 bedrooms.” The user may then ask, “How many of those bedrooms are master bedrooms?” The agent assistant system 104 may determine that the second question is related to the first question based on the fact that the user is likely referring to the same property.

If the same or similar question does exist, the agent assistant system 104, via the query generation system 210, may access a data store for existing information (e.g., queries, vectors, data). In this case, the query generation system 210 may reuse or access related information for input into the LLM for query generation. In some embodiments, the query generation system 210 may access an existing query from the query data store 120 to input into the LLM. As shown, in this case, lower level LLMs may be accessed to generate the query 206, which may be stored in the query data store 120. In some embodiments, the agent assistant system 104 executes few-shot prompting and related techniques based on similar existing queries. For example, the query generation system 210 may search for similar queries or questions stored in a database(s). In the case when the query generation system 210 finds a similar query, it may be retrieved for inclusion with a prompt fed into the LLM for generation of the answer 208. In some cases, the query generation system 210 determines that a second query is similar to the first query based on a vector distance. Similarity may be based on the intent, such that the query generation system 210 will retrieve historical queries with the same intent as the present intent.

If the same or similar question does not exist, the agent assistant system 104, via the query generation system 210, may input the question into an LLM (stored in the LLM data store 118) to generate a query. As used herein, a query may include information parsed from the user question 202. The processes for query generation in this instance may be similar to the processes described with reference to FIGS. 1, 2A-2C, and 3A above. Specifically, as shown in FIG. 3A, the user question 202 may be input into an LLM (or multiple LLMs) for generation of the query 206, which may also be stored in the query data store 120.

To generate an answer, the agent assistant system 104 may execute the generated query 206 to retrieve corresponding data from the query data store 120. The query 206 may correspond to a specific area or location(s) within the query data store 120 associated with the query 206. In response to retrieving information, the agent assistant system 104 may input the accessed information from the query data store 120 into an LLM, such as a lower level LLM (or multiple LLMs). In addition, the agent assistant system 104 may input the generated query 206, retrieved information, user question 202, chat history information, and any other information into the LLM for generation of the answer.

In response to the input, the LLMs may output an answer to the original user question 202 provided by the user. In some embodiments, the answer 208 generated by the LLM may be in various formats. For example, the LLM may output text data (e.g., text response), a table, an image, a picture, or any other format. To generate an answer 208, the LLM may reference various document databases or information stores. In some embodiments, the agent assistant system 104 may transmit the answer 208 to the user via the frontend 116. The answer 208 may be presented to the user via a chat interface, and may be formatted in a natural language format, such as a response in a conversation/dialogue.

FIG. 3B is an example data flow process in which the agent assistant system 104 may operate to generate a confidence score, according to an additional embodiment of the present disclosure. The confidence score generated by the confidence system 302 may estimate the likelihood that the generated query 206 accurately reflects the user's intent.

As shown in FIG. 3B and described herein, the user question 202 may be input by a user to the agent assistant system 104. User question 202 may include any input by the user to the agent assistant system 104, such as a text-based message, an image, a video, a voice or audio message, etc. User question 202 may relate to a request for information regarding properties, clients, potential clients, advertisements, real estate, comparables, and the like. Some questions may involve requests for information stored in databases (e.g., specific property information) or estimates, and as such, may require the generation of a query to retrieve that specific information.

In some embodiments, upon receiving the user question 202, the agent assistant system 104 transmits or inputs the user question 202 to the AI understanding system 108. In some embodiments, the AI understanding system 108 is configured to handle and resolve ambiguities within the information from the user (e.g., question, task) as described above.

The AI understanding system 108 may determine whether the user question 202 contains an ambiguity. In the case when the AI understanding system 108 determines that an ambiguity does not exists, a confidence score will be determined along with the answer 208. In the case when the AI understanding system 108 determines that no ambiguity exists, a confidence score does not need to be determined. It is noted that determination of a confidence score by the confidence system 302 may occur in addition to the other processes of the search and response system 110. This is indicated in FIG. 3B as dotted lines.

In cases where the AI understanding system 108 detects ambiguity in the user question 202, the user question 202 and any identified ambiguous entities may be sent to the clarification system 306 to resolve the ambiguity (see FIG. 3B). The user may be prompted to provide additional information through text input, selection options, or other methods. As a result, query generation may be deferred until a clear user intention is established. Because no query may be generated at this stage, there may be no output from the search and response system 110 and, consequently, no need to calculate a confidence score. The clarification prompt itself may not require a confidence score.

Upon determining the intent of the user question 202, the agent assistant system 104 may trigger the confidence system 302 to generate a confidence score to estimate the likelihood that generated query 206 accurately reflects the user's intent. To determine a confidence score 304, the confidence system 302 may input the user question 202 and the generated query 206 into a model(s) or intelligent agent. The model(s) accessed by the confidence system 302 can be any predictive model, such as an LLM, configured to determine the confidence that the intent of the user input (e.g., user question 202) matches the generated query 206 (“confidence model”).

Confidence model or models (will be referred to as “confidence model” for ease of reference) may be trained to generate a confidence score that indicates a likelihood that the query 206 reflects the user's intent in the user question 202. Training data can include historical data of past user questions and the corresponding generated queries. In addition, the question/query pairs may be labeled as incorrect/correct or labeled with a confidence rating (high/medium/low etc.). During the training phase, the labeled question/query pairs may be input into the confidence model. In some embodiments, the user question alone, the query alone, or a combination of the questions/queries may be input into the confidence model for training. Upon training data input into the confidence model, the confidence model may output a confidence score, which can be a single value, multi-value, or even multi-faceted (e.g., syntax confidence, semantic confidence).

In some embodiments, the confidence system 302 determines, based on the output of the model, whether the selected tables and columns (for generation of the query 206) align with the user's intent. In addition, the confidence system 302 may determine whether the logic of the query 206 matches the semantics of the user question 202. In addition, the confidence system 302 may determine, based on the model's output, the likelihood that the query 206 will return a valid and/or relevant result. Based on these evaluations and any other indicative of aligned intent, the confidence system 302 may generate a confidence score. In some embodiments, the confidence system 302 utilizes retrieval-augmented generation (RAG) to retrieve similar, historically successful queries as references to boost the model's accuracy in determining confidence. Based on the alignment quality between the user question 202 and the query 206, the confidence system 302 may output a confidence score 304. Confidence score 304 may be a number, percentage, binary, fraction, descriptor, or any other indicator (e.g., syntax confidence, semantic confidence) of the likelihood that generated query 206 accurately reflects the user's intent in the user question 202. In some embodiments, the confidence system 302 accesses multiple models or intelligent agents to determine multiple scores relating to the likelihood that the user's intent aligns with the query 206. The confidence system 302 may combine, aggregate, average, or otherwise determine a final confidence score 304. In some embodiments, the confidence score 304 is output, such as on a display, to the user along with the answer 208.

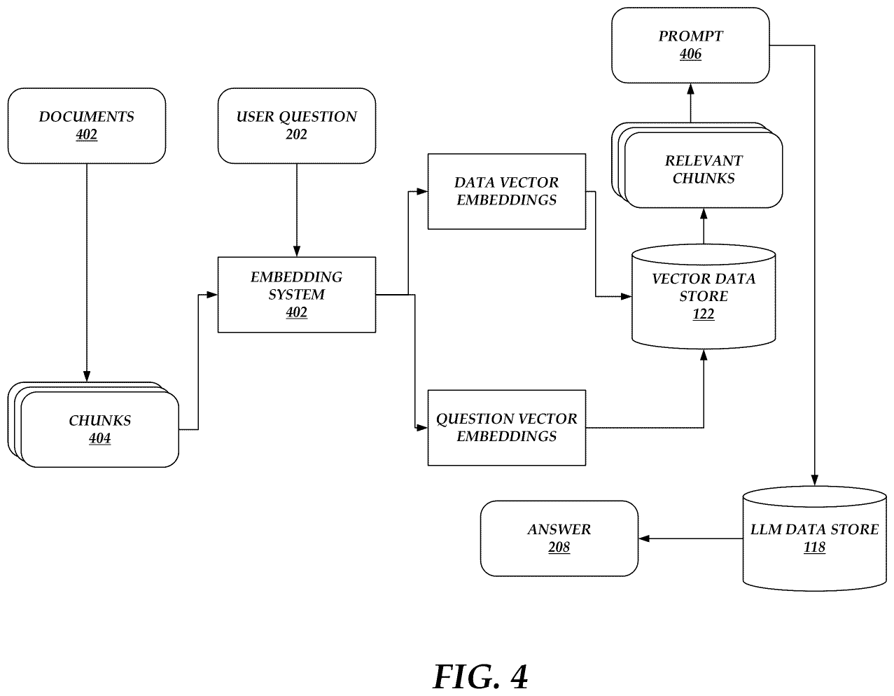

FIG. 4 is an example data flow process in which the query generation system 210 of the agent assistant system 104 may operate to generate a query when data is stored in a vector data store, according to an additional embodiment of the present disclosure.

As shown in FIG. 4, the agent assistant system 104 may access and process document data. Document(s) 402 include any document, file, information, data, etc. that may be considered relevant to the processes performed by the agent assistant system 104. For example, document(s) 402 may include comparables, deeds, insurance forms, reports, agreements, contracts, information sheets, spreadsheets, and/or any document that may be useful to an agent, client, contractor, etc. These documents 402 may be useful in allowing the agent assistant system 104 to answer questions related to properties, clients, real estate industry, and the like. Document(s) 402 may be accessed by the agent assistant system 104 over the network 124.

To process accessed document(s) 402, the agent assistant system 104 may extract text or other content from the document(s) 402 and split into chunks. In some embodiments, document(s) 402 may be divided into chunks. Chunks 404 may be associated with vector embeddings and further indexed and stored in the vector data store 122.

In addition to storage of document data in vector embeddings, the agent assistant system 104 may also execute similar processes with the user question 202 (shown in FIG. 4 as a “user query”). As described herein, the agent assistant system 104 may access a user question 202. User question 202 may include any input by the user to the agent assistant system 104, such as a text-based message, an image, a video, a voice or audio message, etc. User question 202 may relate to a request for information regarding properties, clients, potential clients, advertisements, real estate, comparables, and the like. Some questions may involve requests for information stored in databases (e.g., specific property information) or estimates, and as such, may require the generation of a query to retrieve that specific information.

In some embodiments, the agent assistant system 104 generates a prompt 406 for input into the LLM. Prompt 406 may include the user question 202 and any relevant information from data stores. To generate the prompt 406, the agent assistant system 104 (such as via the query generation system 210) may parse the user question 202. As shown in FIG. 4, the user question 202 may be split into question vector embeddings. The agent assistant system 104 may perform a similarity search within the vector data store 122 using the question vector embeddings. In some embodiments, the agent assistant system 104 executes few-shot prompting and related techniques based on similar existing queries. For example, the query generation system 210 may search for similar queries or questions stored in a database(s). In the case when the query generation system 210 finds a similar query, it may be retrieved for inclusion with the prompt 406. In addition, in response to the similarity search, the agent assistant system 104 may determine or retrieve relevant chunks (e.g., vector embeddings) related to document data that are related to the question vector embeddings. This information may be utilized by the agent assistant system 104 (or the query generation system 210) in generating the query 206.

Similar to the processes described above, upon generation of the prompt 406, the agent assistant system 104 may input the prompt 406 into an LLM (or multiple LLMs, such as stored in the LLM data store 118) to generate an answer 208. In some embodiments, the relevant chunks are input along with the generated prompt 406. In some cases, the retrieval system 212 access a single LLM or multiple LLMs in generating an answer based on the query. In some embodiments, the answer generated by the LLM may be in various formats. For example, the LLM may output text data, a table, an image, a picture, or any other format. To generate an answer 208, the LLM may reference various document databases or information stores.

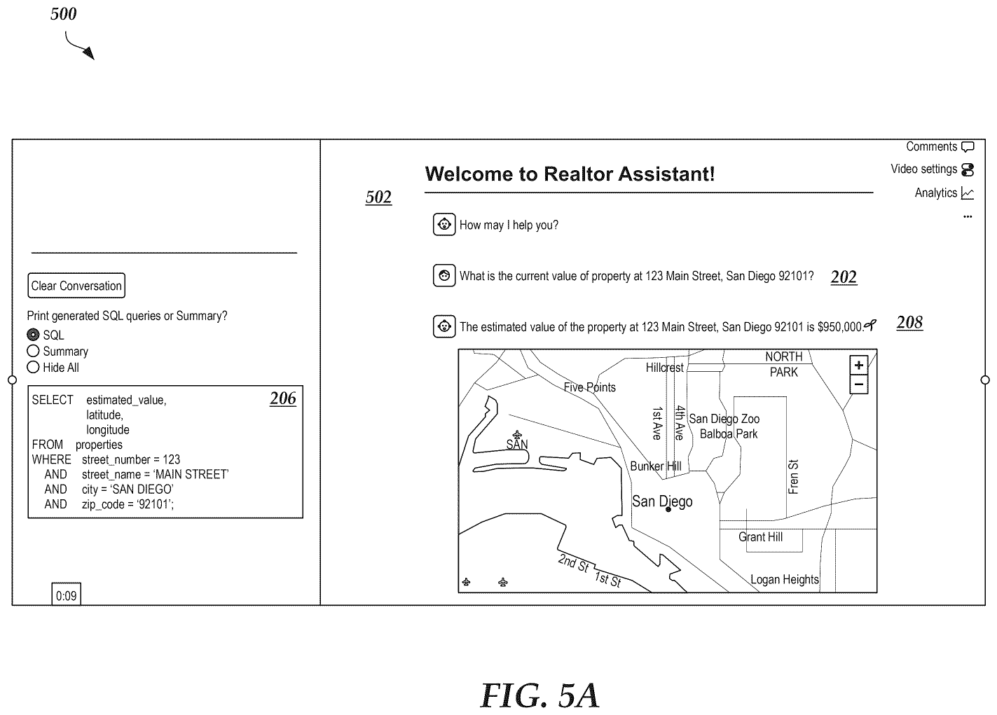

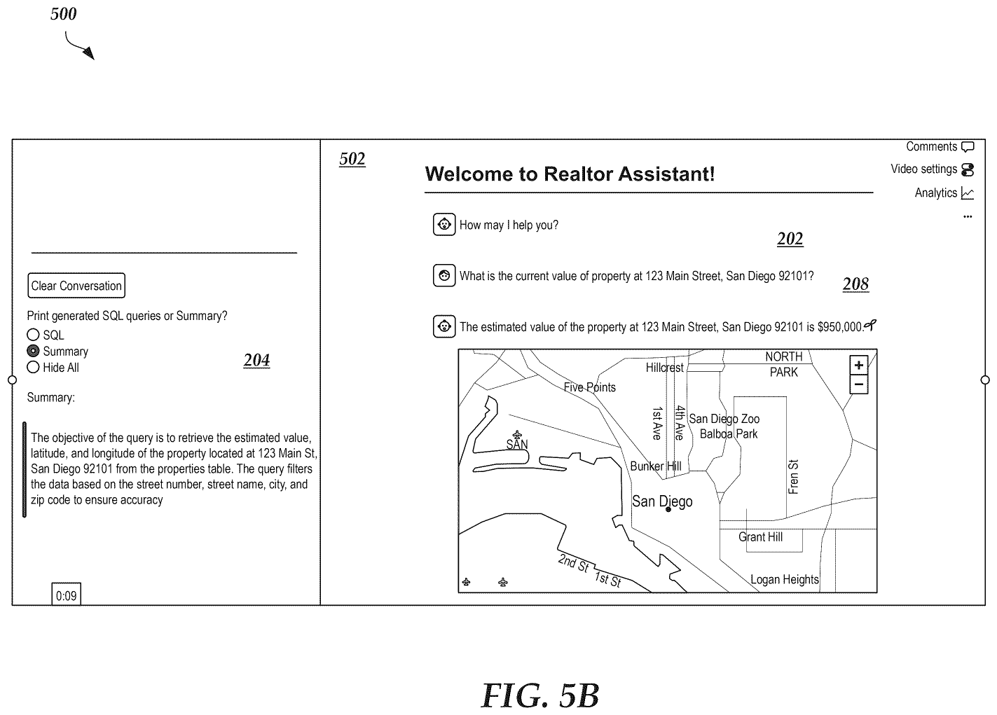

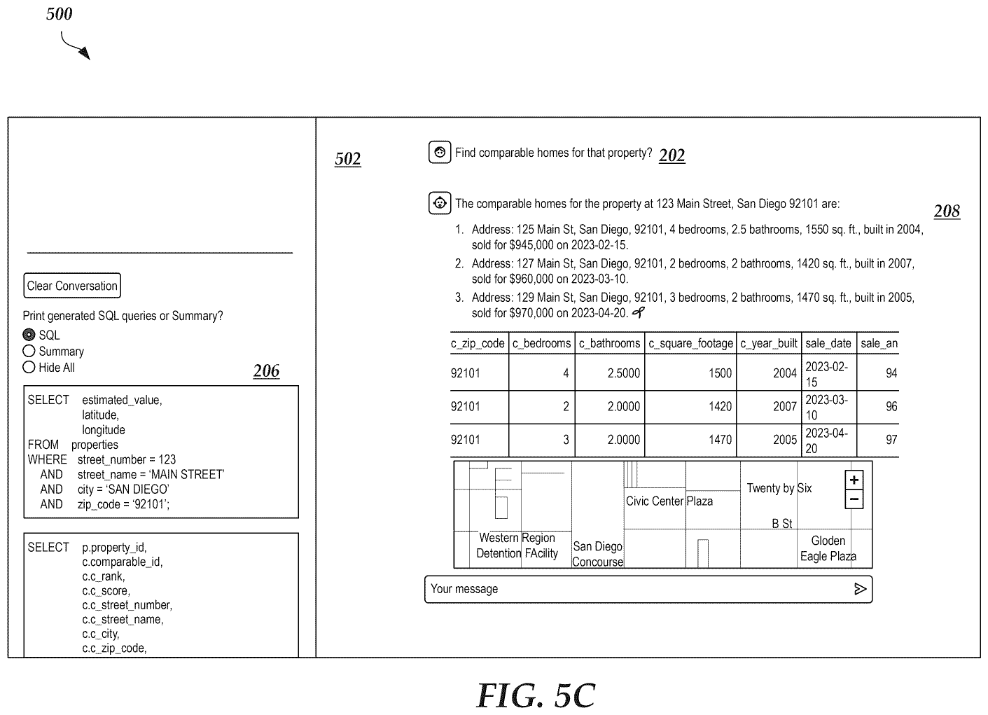

FIG. 5A-5C are screenshots of example chat interface 500 through which a user may interact with the agent assistant system 104, according to various aspects of the present disclosure.

FIG. 5A is an example screenshot of chat interface 500 through which a user may interact with the agent assistant system 104, such as via the frontend 116. The chat interface 500 may include various areas or components that may be displayed in the frontend 116. As shown, the chat interface 500 may include dialogue area 502, which may display a chat history between the user and the agent assistant system 104. As described herein, the user may input (e.g., type) a user question 202 into the interface 500. The user question 202 may be shown in the dialogue area 502. The dialogue area 502 may display the chat history between the user and the agent assistant system 104 as messages are generated.

Upon input of the user question 202, the agent assistant system 104 may generate the answer 208. In addition to displaying the answer 208 in the dialogue area 502, the agent assistant system 104 may also display the query 206. As shown in the chat interface 500, the query 206 may be shown in a separate area for a user to view. In some embodiments, the agent assistant system 104 may display the query 206 at the same, earlier, or later time, that the answer 208 is shown in the dialogue area 502.

FIG. 5B is an example screenshot of the chat interface 500 through which a user may interact with the agent assistant system 104. In this figure, the agent assistant system 104 may display the summary 204 in the chat interface 500. The summary 204 may correspond to the query 206 and the answer 208 as shown in the dialogue area 502.

FIG. 5C is an example screenshot of the chat interface 500 through which a user may interact with the agent assistant system 104 to answer multiple questions. In some embodiments, the user may continue a dialogue with the agent assistant system 104 to answer multiple questions that are related. For example, the question 202 (“Find comparable homes for that property?”) may be related to a previous question asked by the user in the chat history. As such, the agent assistant system 104 may generate an additional answer for display in the dialogue area 502.

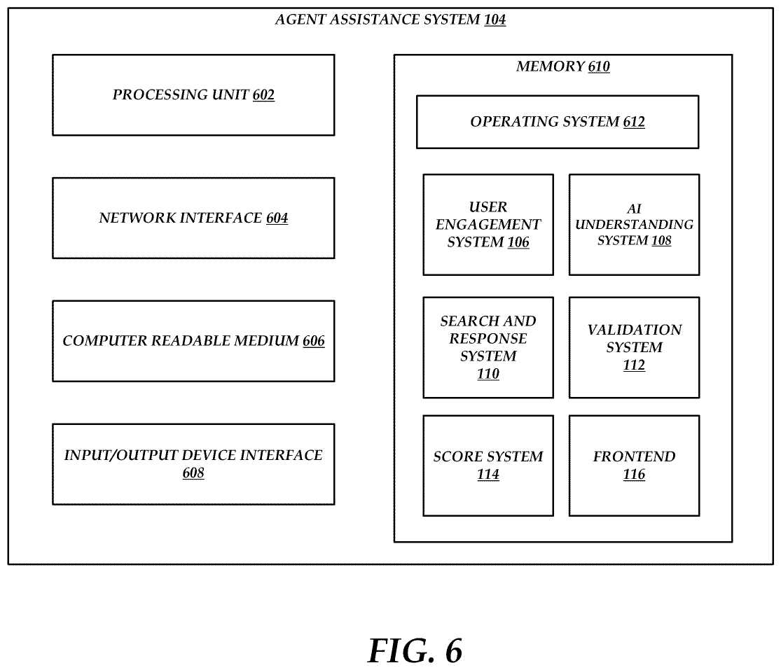

FIG. 6 is a block diagram illustrating components of an example computing system that can be used to implement the various systems and methods described herein.

The general architecture of the system depicted in FIG. 6 includes an arrangement of computer hardware and software that may be used to implement aspects of the present disclosure. The hardware may be implemented on physical electronic devices, as discussed in greater detail below. The system may include many more (or fewer) elements than those shown in FIG. 6. It is not necessary, however, that all of these generally conventional elements be shown in order to provide an enabling disclosure. Additionally, the general architecture illustrated in FIG. 6 may be used to implement one or more of the other components illustrated in the figures. As illustrated, the system includes a processing unit 602, a network interface 604, a computer-readable medium drive 606, and an input/output device interface 608, and memory 610, all of which may communicate with one another by way of a communication bus.

The network interface 604 may provide connectivity to one or more networks or computing systems. The processing unit 602 may thus receive information and instructions from other computing systems or services via the network. The processing unit 602 may also communicate to and from memory 610 and further provide output information for an optional display (not shown) via the input/output device interface 608. The input/output device interface 508 may also accept input from an optional input device (not shown).

The memory 610 may contain computer program instructions (grouped as units in some embodiments) that the processing unit 602 executes in order to implement one or more aspects of the present disclosure, along with data used to facilitate or support such execution. While shown in FIG. 6 as a single set of memory 610, memory 610 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

The memory 610 may store an operating system 612 that provides computer program instructions for use by the processing unit 602 in the general administration and operation of the agent assistant system 104. The memory 610 may further include computer program instructions and other information for implementing aspects of the present disclosure. For example, in one embodiment, the memory 510 includes the user engagement system 106, the AI understanding system 108, the search and response system 110, the validation system 112, the score system 114, and the frontend 116. Each of these components may represent code executable to perform the processes described herein.

The system of FIG. 6 is one illustrative configuration of such a device, of which others are possible. For example, while shown as a single device, a system may in some embodiments be implemented as a logical device hosted by multiple physical host devices. In other embodiments, the system may be implemented as one or more virtual devices executing on a physical computing device. While described in FIG. 6 as an agent assistant system 104, similar components may be utilized in some embodiments to implement other devices shown herein.

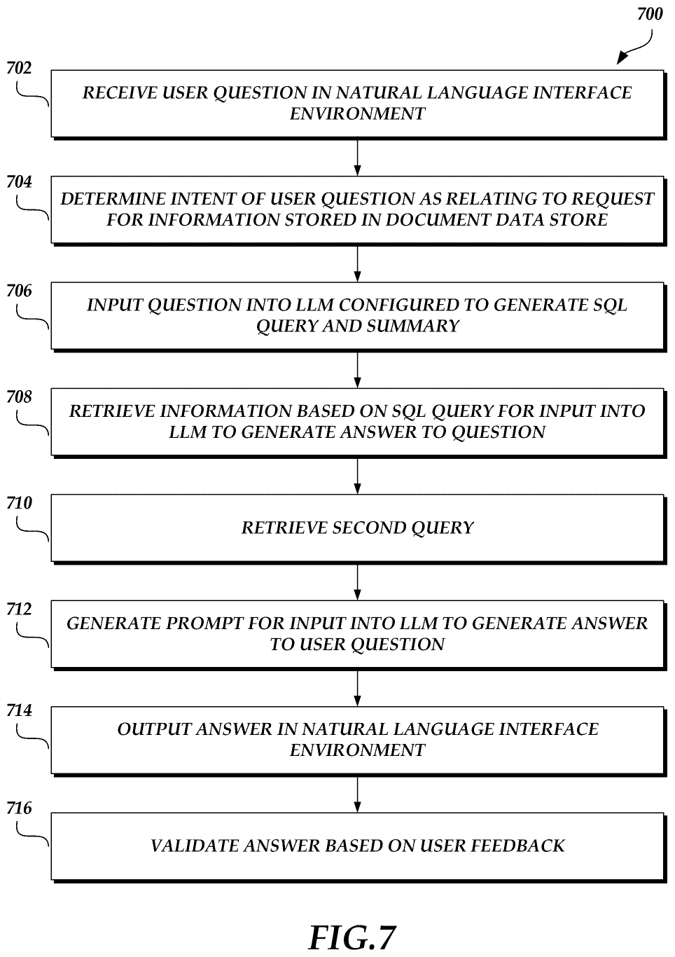

FIG. 7 is a flow diagram showing an example routine 700 for generating an answer to a question based on an intermediate SQL query or CQL query, according to various aspects of the present disclosure. Routine 700 may be executed by the agent assistant system 104 and various components of the agent assistant system 104. Specifically, the routine 700 may be executed by a processor, such as the processing unit 602, shown in FIG. 6.

At block 702, a user question 202 may be received in a natural language interface environment. As described herein, the agent assistant system 104 may provide a natural language environment (e.g., a chat interface) to receive tasks or questions from a user, such as user question 202. User question 202 may include any input by the user to the agent assistant system 104, such as a text-based message, an image, a video, a voice or audio message, etc. User question 202 may relate to a request for information regarding properties, clients, potential clients, advertisements, real estate, comparables, and the like. Some questions may involve requests for information stored in databases (e.g., specific property information) or estimates, and as such, may require the generation of a query to retrieve that specific information. In some embodiments, the agent assistant system 104 accesses a user profile to provide auto-complete suggestions or recommendations to the user while the user enters the user question 202. For example, based on past queries, the agent assistant system 104 may determine that the user has searched for properties in Austin, TX. Upon determining that the user is currently typing the question “Find single family homes in,” the agent assistant system 104 may suggest the autocomplete suggestion “Austin, TX” for the user to select.

At block 704, the agent assistant system 104 determines an intent of the user question. In some embodiments, the user question 202 relates to a request for information stored in a document data store. For example, the agent assistant system 104 may determine whether the user question 202 requires a query-based answer based on an intent of the question. Some questions may involve requests for information stored in databases (e.g., specific property information) or estimates, and as such, may require the generation of a query to retrieve that specific information. Some questions may not involve requests for specific information, or may be handled by other processes (e.g., lower level LLMs). As such, depending on the level of complexity of the question and the available resources, the agent assistant system 104 may determine whether or not the user question 202 requires a query-generated answer from the LLM (e.g., is “not relevant” to the query generation system 210).

In some embodiments, the agent assistant system 104 determines whether there is an ambiguity (or multiple ambiguities) in the user question 202. The agent assistant system 104 may determine ambiguity before, after, or parallel to the processes at block 704. As described herein, the agent assistant system 104 may identify any one or a combination of a location ambiguity, a property characteristic ambiguity, a valuation or pricing ambiguity, a property status or availability ambiguity, a property type ambiguity, or any other unclear phrase or word within the user question 202 that can result in multiple interpretations.

In some embodiments, before the agent assistant system 104 proceeds to block 706, the agent assistant system 104 attempts to resolve the ambiguity. To do so, the agent assistant system 104 may prompt the user to provide additional information or clarity regarding the user question 202. In some embodiments, the agent assistant system 104 may present, in the natural language interface, a follow up question or prompt to the user to provide input, such as via a checkbox, a list, a textbox, etc. For example, the user question 202 may request the agent assistant system 104 to retrieve “new homes in Phoenix, AZ under $400,000.” The agent assistant system 104 may determine that the phrase “new homes” is ambiguous, as it is not clear whether the user is referring to newly built homes or newly listed homes. In response to determining that an ambiguity exists, the agent assistant system 104 may display a natural language inquiry to the user and/or options for the user: “To ensure that I find the right homes for you, could you please specify what you mean by “new homes? ( ) Newly-listed homes ( ) Newly built homes.” The user may then select or enter information to resolve the ambiguity. If the ambiguity persists, the agent assistant system 104 may generate additional prompts or inquiries to the user to resolve the ambiguity. The solution or information to resolve the ambiguity may be utilized by the agent assistant system 104 in generation of the query for input into the LLM.

At block 706, the agent assistant system 104 may input the user question 202 into an LLM configured to output an SQL query and summary based on the intent of the user question 202. For example, the agent assistant system 104 may input the question into an LLM (stored in the LLM data store 118) to generate a query. As used herein, a query may include information parsed from the user question 202. The processes for query generation in this instance may be similar to the processes described with reference to FIGS. 1, 2A-2C, and 3A-3B above.

In some embodiments, the SQL query may be stored by the agent assistant system 104 in the query data store 120. The queries may be utilized by the agent assistant system 104 to generate a user profile. As discussed herein, the user profile can include information relating to a user's behavior, interest, past searches/questions/inquiries, patterns, preferences, and the like. In some embodiments, based on the inquiries (e.g., user question 202) sent to the agent assistant system 104 by the user, the agent assistant system 104 may maintain the inquiries to further personalize the user profile. The agent assistant system 104 may determine a similarity of each user question 202 with past questions stored in the query data store 120. In some embodiments, the agent assistant system 104 utilizes or accesses a model to determine a similarity (e.g., semantic similarity, cosine distance or cosine similarity based on a vector derived from a new question 202 and one or more vectors derived from previous question(s), etc.) between a new question 202 and a previous question or a previous set of questions. Each question may be associated with a similarity score, or may be stored in the query data store 120 within a vector space or other embedding space. Similarities or dissimilarities between questions may indicate a trend or new behavior of the user. For example, a low similarity score (e.g., a similarity score less than 50, less than 25, less than 10, etc. on a scale of 0-100) associated with a new question 202 may indicate that the user is exhibiting a new trend or behavior. In some embodiments, agent assistant system 104 generates and maintains the user profile based on the generated queries (originating from the user question 202).

Specifically, as shown in FIG. 3A, the user question 202 may be input into an LLM (or multiple LLMs) for generation of the query 206, which may also be stored in the query data store 120. In addition, the generated summary 204 may represent the information parsed from the user question 202 and the task to be executed by the LLM, expressed in natural language. The summary 204 may serve as a check or validation to confirm that the LLM will generate an accurate response. For example, a user may view the summary 204 in the frontend 116 to confirm that the answer generated by the agent assistant system 104 is correct.

At block 708, the agent assistant system 104 retrieves information from a document data store based on an SQL query. The SQL query may correspond to a specific area or location (or multiple locations/areas) in the query data store 120 for storing information.

At block 710, the agent assistant system 104 retrieves a second query to the generated SQL query. In some embodiments, the agent assistant system 104 executes few-shot prompting and related techniques based on similar existing queries. For example, the query generation system 210 may search for similar queries or questions stored in a database(s). In the case when the query generation system 210 finds a similar query, it may be retrieved for inclusion with a prompt fed into the LLM for generation of the answer 208. In some cases, the query generation system 210 determines that a second query is similar to the first query based on a vector distance. The second query may be associated with the intent based on a vector distance. In some embodiments, similarity may be based on the intent, such that the query generation system 210 will retrieve historical queries with the same intent as the present intent.

At block 712, in response to retrieving the information from the query data store 120, the agent assistant system 104 (such as the retrieval system 212) generates a prompt for input into an LLM. In some embodiments, the prompt is generated based on any combination of the SQL query, the similar (or second) query, the user question, and the retrieved information from the document data store. In some cases, the prompt is generated based on a conversation history. The agent assistant system 104 may input the information into an LLM (or multiple LLMs, such as stored in the LLM data store 118) to generate an answer 208. In some cases, the retrieval system 212 accesses a single LLM or multiple LLMs in generating an answer based on the retrieved database information. In some embodiments, the agent assistant system 104 generates or accesses results or recommendations based on the user profile. In addition, new features or results may be recommended to the user as the answer.

At block 714, the answer 208 is output in the natural language interface environment. As described herein, in some embodiments, the agent assistant system 104 may transmit the answer 208 to the user via the frontend 116. The answer 208 may be presented to the user via a chat interface, and may be formatted in a natural language format, such as a response in a conversation/dialogue.

At block 716, the answer 208 may be validated based on user feedback. In some embodiments, the validation system 112 may be configured to validate responses generated by the agent assistant system 104. For example, the user may respond to the generated answer 208 by providing feedback. Feedback can include any indication from the user relating to the answer 208, such as a positive response (e.g., thumbs up, liking a response message), a negative response (e.g., thumbs down, disliking a response message), any other emotion or reaction, or a comment.

In some embodiments, at block 716, the validation system 112 may utilize feedback provided by the user to adjust various components of the agent assistant system 104. In some embodiments, the feedback collected by the validation system 112 may be used to train the LLMs stored in the LLM data store 118.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system, comprising:
a computer-readable storage medium storing program instructions; and
one or more processors configured to execute the program instructions to cause the system to:
receive a user question in a natural language interface environment;
determine an intent of the user question, wherein the intent relates to a request for information stored in a document data store;
input the user question into a large language model (LLM), wherein the LLM is configured to generate:
an SQL query based on the intent of the user question and requested information from the document data store, and
a natural language summary of the SQL query;
retrieve information from the document data store based on the SQL query;
retrieve a second query associated with the intent of the user question based on a vector distance;
generate a prompt based on the SQL query, the second query, the user question, and the retrieved information from the document data store for input into the LLM to generate an answer to the user question;
output the answer in the natural language interface environment; and
validate the answer based on user feedback received within the natural language interface environment.

2. The system of claim 1, wherein the program instructions further cause the system to:
determine an ambiguity within the user question;
display, within the natural language interface environment, an inquiry to resolve the ambiguity; and
receive, from a user, a response to the inquiry that resolves the ambiguity.

3. The system of claim 1, wherein the program instructions further cause the system to:
display the natural language summary in the natural language interface environment.

4. The system of claim 1, wherein the answer is at least one of a text response, a table, an image, or a picture.

5. The system of claim 1, wherein the user feedback to the answer includes at least one of a positive response, a negative response, an emotion, a reaction, or a comment.

6. The system of claim 1, wherein the program instructions further cause the system to:
generate a user profile based on the SQL query and the second query; and
wherein the LLM is to generate the answer based on a user profile.

7. The system of claim 1, wherein the second query was generated within a current session or a prior session.

8. A computer-implemented method, comprising:
receiving a user question in a natural language interface environment;
determining an intent of the user question, wherein the intent relates to a request for information stored in a document data store;
inputting the user question into a large language model (LLM), wherein the LLM is configured to generate:
an SQL query based on the intent of the user question and requested information from the document data store, and
a natural language summary of the SQL query;
retrieving information from the document data store based on the SQL query;
retrieving a second query associated with the intent of the user question based on a vector distance;
generating a prompt based on the SQL query, the second query, the user question, and the retrieved information from the document data store for input into the LLM to generate an answer to the user question;
outputting the answer in the natural language interface environment; and
validating the answer based on user feedback received within the natural language interface environment.

9. The computer-implemented method of claim 8, further comprising:
determining an ambiguity within the user question;
displaying, within the natural language interface environment, an inquiry to resolve the ambiguity; and
receiving, from a user, a response to the inquiry that resolves the ambiguity.

10. The computer-implemented method of claim 8, wherein the computer-implemented method further comprises:
displaying the natural language summary in the natural language interface environment.

11. The computer-implemented method of claim 8, wherein the answer is at least one of a text response, a table, an image, or a picture.

12. The computer-implemented method of claim 8, wherein the user feedback to the answer includes at least one of a positive response, a negative response, an emotion, a reaction, or a comment.

13. The computer-implemented method of claim 8, wherein the computer-implemented method further comprises:
generating a user profile based on the SQL query and the second query; and
wherein the LLM is to generate the answer based on a user profile.

14. The computer-implemented method of claim 8, wherein the second query was generated within a current session or a prior session.

15. A non-transitory, computer-readable medium comprising computer-executable instructions for generating an answer to a user question, wherein the computer-executable instructions, when executed by a computer system, cause the computer system to:
receive the user question in a natural language interface environment;
determine an intent of the user question, wherein the intent relates to a request for information stored in a document data store;
input the user question into a large language model (LLM), wherein the LLM is configured to generate:
an SQL query based on the intent of the user question and requested information from the document data store, and
a natural language summary of the SQL query;
retrieve information from the document data store based on the SQL query;
retrieve a second query associated with the intent of the user question based on a vector distance;
generate a prompt based on the SQL query, the second query, the user question, and the retrieved information from the document data store for input into the LLM to generate the answer to the user question;
output the answer in the natural language interface environment; and
validate the answer based on user feedback received within the natural language interface environment.

16. The non-transitory, computer-readable medium of claim 15, wherein the computer-executable instructions, when executed, further cause the computer system to:
determine an ambiguity within the user question;
display, within the natural language interface environment, an inquiry to resolve the ambiguity; and
receive, from a user, a response to the inquiry that resolves the ambiguity.

17. The non-transitory, computer-readable medium of claim 15, wherein the computer-executable instructions, when executed, further cause the computer system to:
display the natural language summary in the natural language interface environment.

18. The non-transitory, computer-readable medium of claim 15, wherein the user feedback to the answer includes at least one of a positive response, a negative response, an emotion, a reaction, or a comment.

19. The non-transitory, computer-readable medium of claim 15, wherein the computer-executable instructions, when executed, further cause the computer system to:
generate a user profile based on the SQL query and the second query; and
wherein the LLM is to generate the answer based on a user profile.

20. The non-transitory, computer-readable medium of claim 15, wherein the second query was generated within a current session or a prior session.
